(19) United States
(12) Patent Application Publication
(10) Pub. No.: US 2024/0070756 A1
(43) Pub. Date: Feb. 29, 2024

(54) VEHICULAR AUTOMATED COMMUNICATION SYSTEM FOR WIRELESSLY COMMUNICATING WITH EXTERNAL SYSTEM

(71) Applicant: Magna Electronics Inc., Auburn Hills, MI (US)

(72) Inventors: Suresh Boddi, New Hudson, MI (US); Jeremy J. Baca, Ann Arbor, MI (US); James G. Oldiges, Waterford, MI (US); Naresh Ravuri, Novi, MI (US)

(21) Appl. No.: 18/454,236

(22) Filed: Aug. 23, 2023

Related U.S. Application Data
(60) Provisional application No. 63/373,376, filed on Aug. 24, 2022.

(51) Int. Cl. G06Q 30/0601; G06Q 20/40; G06Q 50/12; H04M 1/72409; H04W 4/021

(52) U.S. Cl. CPC G06Q 30/0635; G06Q 20/4014; G06Q 30/0643; G06Q 50/12; H04M 1/724098; H04W 4/021

(57) ABSTRACT

A vehicular communication system includes an electronic control unit (ECU) at a vehicle. When the vehicle is within a threshold distance of a venue, the vehicular communication system is in wireless communication with a communication device at the venue. The communication device wirelessly communicates information to the vehicle. The communicated information includes information related to at least one of a product or service provided at the venue. Based at least in part on processing at the ECU of the communicated information, a customer order from an occupant of the vehicle is wirelessly transmitted from the vehicle to the communication device at the venue.

### CROSS REFERENCE TO RELATED APPLICATION

The present application claims the filing benefits of U.S. provisional application Ser. No. 63/373,376, filed Aug. 24, 2022, which is hereby incorporated herein by reference in its entirety.

### FIELD OF THE INVENTION

The present invention relates generally to a vehicular communication system for a vehicle and, more particularly, to a vehicular communication system that enables wireless communications between a driver of the vehicle and an external system.

### BACKGROUND OF THE INVENTION

It is known to wirelessly connect the microphone and speakers of a vehicular audio system with a mobile device of a driver to enable hands free calling capabilities within the vehicle.

### SUMMARY OF THE INVENTION

A vehicular communication system includes an electronic control unit (ECU) including electronic circuitry and associated software. The electronic circuitry includes a wireless communication module, such as a transmitting and/or receiving antenna. The communication system, when a vehicle equipped with the communication system is within a threshold distance of a communication module (e.g., a transmitting and/or receiving antenna), is configured to enable wireless communications between the communication system and the external system. The communication device may be at a geographic location or business entity or venue associated with the external system, such as a restaurant having a suitably equipped drive thru ordering system, and the threshold distance may be any suitable distance for wireless connectivity (e.g., BLUETOOTH™ connectivity), such as less than or equal to 1,000 meters, less than or equal to 500 meters, less than or equal to 100 meters, less than or equal to 10 meters, less than or equal to 5 meters, less than or equal to 3 meters, and the like. The communication system, via the wireless communication module, is configured to wirelessly transmit signals to the communication device of the external system and to wirelessly receive signals from the communication device of the external system. The communication system, responsive to a user input from a user of the communication system at an interior portion of the vehicle, wirelessly transmits a signal based on the user input to the external system. For example, the user input may be an audio input or an input received a touchscreen display device of the vehicle. The communication system, responsive to receiving an external signal from the external system, displays a message to the user based on the external signal. For example, the communication system may play audio over speakers of the vehicle or display images (e.g., a menu) at the display device.

These and other objects, advantages, purposes and features of the present invention will become apparent upon review of the following specification in conjunction with the drawings.

### BRIEF DESCRIPTION OF THE DRAWINGS

FIG. 1 is a perspective view of a vehicle equipped with the vehicular communication system;

FIG. 2 is an environmental view of the vehicle within a threshold distance of a communication module of an external system to enable wireless communications between the vehicular communication system and the external system;

FIG. 3 is a schematic view of a display at the interior portion of the vehicle displaying a prompt for a user to accept or decline connection to the external system; and

FIGS. 4 and 5 are schematic views of the display displaying an interface based on communications received from the external system.

### DESCRIPTION OF THE PREFERRED EMBODIMENTS

A vehicular communication system operates to wirelessly communicate with an external or remote system having a transmitting and/or receiving antenna at a geographical location or business entity or venue proximal to a vehicle equipped with the communication system so that a driver and/or occupant of the vehicle may communicate with the external system regarding a service provided at the location. When the vehicle is within range of the antenna of the external system, the communication system may prompt the driver or occupant (i.e., a user) to accept or confirm connection to the external system and, after the user accepts or confirms connection, the communication system enables one-way or two-way communication between the user and the external system. For example, the communication system may enable audio communication to and from the user utilizing microphones and speakers disposed at the interior cabin of the vehicle and/or the communication system may exchange messages with the external system based on inputs received and images displayed at an infotainment display at the vehicle.

In some implementations, the communication system wirelessly connects the vehicle's audio systems (e.g., speakers and microphones) to a drive thru or drive-up ordering system at a business or restaurant so that the users may communicate with the drive thru ordering system through the vehicle's audio systems instead of traditional methods (e.g., where the driver lowers a window of the vehicle to speak to an external microphone/speaker system at the business or to speak directly to an employee of the business). Furthermore, the communication system may receive information or signals from the ordering system to display images or messages (such as displaying a menu or information related to an order being placed) at a display within the vehicle, such as an infotainment display screen at the center console of the vehicle. The infotainment screen may accept inputs to construct and place an order and provide payment information to the ordering system. In other words, the users, via the communication system, may view the menu, construct and place an order (via verbal communications or at the infotainment screen), and provide payment information to the restaurant.

Thus, the communication system allows the user to wirelessly communicate with the external system when the vehicle is within range of the antenna or communication module of the external system. The communication system provides an improved method of communication between the users and the business (or other recipient having the external system) as use of the vehicle systems for communication (e.g., microphones, speakers, and/or inputs at the infotainment screen) improves clarity of communication and comfort of the user over traditional methods of communication. That is, sometimes, such as due to weather conditions or vehicle noise, it is difficult to communicate via drive thru speaker systems (or communication may be undesirable due to rain or extreme temperature conditions). The communication system enables contactless communication that allows the user to avoid opening windows while ordering in bad/adverse weather conditions. Additionally, the communication system allows the driver or any occupant within the vehicle to easily communicate with the external system, improving efficiency of ordering systems because the driver is not being relied upon for communicating on behalf of all vehicle occupants.

Although described herein as wirelessly connecting the vehicle and users to a drive thru ordering system at a restaurant, it should be understood that the communication system may wirelessly connect the vehicle and users to a variety of different external systems associated with a variety of geographic locations, venues, businesses, and service locations, non-limiting examples of which are provided below. For example, the communication system may enable communications between the driver and external systems associated with drive thru or drive-in or curbside pickup locations or businesses (such as restaurants, drive-in movie theaters, banks, pharmacies, grocery and retail stores (for pickup of previously ordered items) and the like), appointment-based location or business (such as doctor offices, veterinary offices and the like), schools (such as for pickup and drop off of children), government service locations, or nature sites such as state parks, and the like.

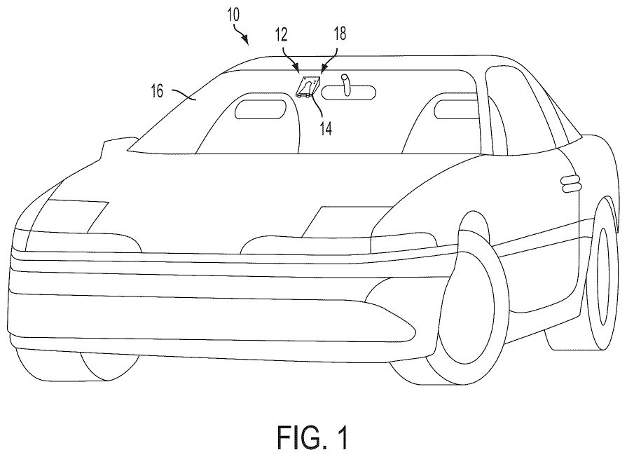

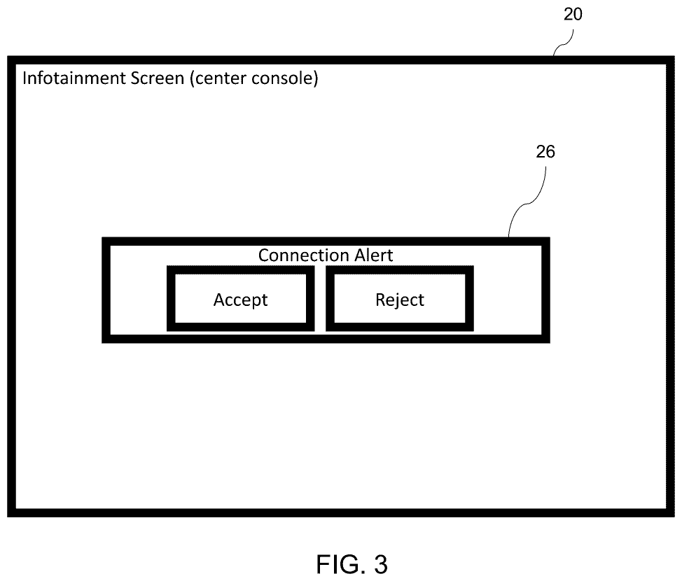

Referring now to the drawings and the illustrative embodiments depicted therein, a vehicle 10 equipped with the communication system 12 may include an electronics module 14 disposed at an inner portion of the vehicle 10, such as mounted to an interior surface of the vehicle, such as a headliner or in-cabin surface of a windshield 16 (FIG. 1). The electronics module 14 houses a control or electronic control unit (ECU) 18 having electronic circuitry and associated software. For example, the electronics module or the ECU 18 may include a wireless communication module (e.g., a transmitting and/or receiving antenna) so that the communication system 12 may wirelessly communicate with the antenna of the external system at the geographic location to transmit and/or receive messages when the vehicle 10 is within a range of the antenna. As discussed further below, the vehicle 10 may be equipped with one or more sensors, such as one or more cameras, disposed at the vehicle (e.g., a driver monitoring camera viewing a head region of the driver of the vehicle, and/or a plurality of exterior cameras having a respective camera disposed at the front, rear and sides (such as at exterior rearview mirrors of the vehicle) and/or the like). Thus, the electronic circuitry may include a data processor or image processor that is operable to process image data captured by the camera or cameras. The ECU 18 may provide displayed images at a display device 20 (FIG. 3) for viewing and interaction by the users of the communication system 12, such as an infotainment display at a center console of the vehicle. The display device 20 may comprise a touch screen device operable to receive inputs from the user or the system 12 may receive inputs via actuatable buttons at the interior of the vehicle that are associated with selectable options presented at the display 20. The data transfer or signal communication from the camera and/or wireless communication module to the ECU may comprise any suitable data or communication link, such as a vehicle network bus or the like of the equipped vehicle.

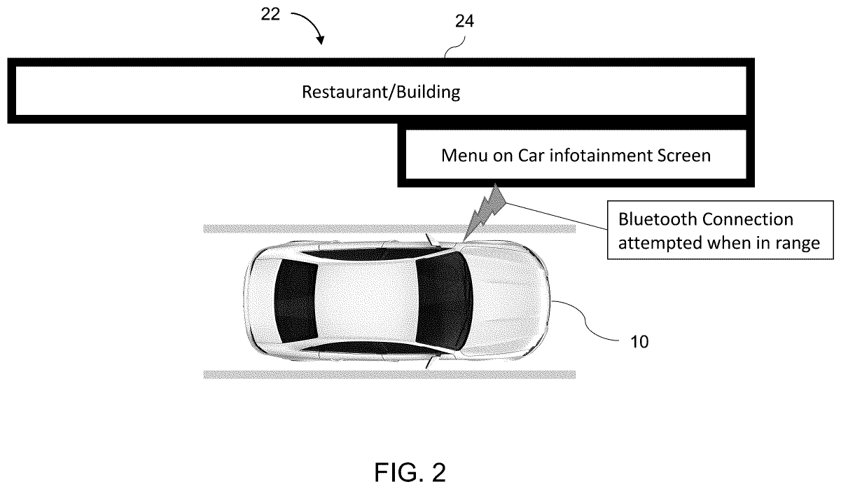

In the illustrated example of FIG. 2, the external system 22 is associated with a restaurant and an antenna 24 is located at the restaurant. The vehicle 10 is adjacent the restaurant, such as in a parking lot or drive thru lane at the restaurant, and, when the vehicle 10 is within range of the external system 22, the communication system 12 wirelessly connects to the external system 22. That is, when the antenna 24 of the external system 22 is within a threshold distance of the electronics module 14 of the communication system 12 (such as less than less than 100 meters, less than 10 meters, less than 5 meters, less than 3 meters, less than 1 meter, or the like) a wireless communications connection is established between the communication system 12 and the external system 22. The communication system 12 may be configured to connect with the external system 22 via BLUETOOTH® connection or any suitable wireless connection (e.g., DSRC (dedicated short range communications) or WiFi, ZigBee and the like). For example, BLUETOOTH® technology may be configured to provide connectivity between the communication system 12 and the external system 22 when the wireless communication module of the communication system 12 is within range of the antenna 24 of the external system. The threshold distance or range for establishing wireless communications may be based on connectivity capabilities of the communication system 12 and/or the external system 22 and thus the range for connectivity may be any suitable distance, such as 1 meter or less or 20 meters or less or 100 meters or more.

Establishment of the wireless connection may occur automatically when the vehicle 10 is within the threshold range of the external system 22. For example, one or both of the communication system 12 and the external system 22 may passively or episodically transmit connection request signals and, when a signal is detected from the other system, this indicates that the vehicle and external system 22 are within the threshold range of one another and the communication connection is established. The threshold range may be based on the transmission capabilities of the communication module of the communication system 12 and/or the antenna of the external system 22. Thus, when the vehicle 10 travels within range of the antenna 24 at the restaurant (e.g., enters the parking lot), the communication system 12 may receive a wireless communication from the external system 22 to initiate connection. The driver or occupant of the vehicle may accept or decline the connection.

Optionally, the communication system 12 may search for and connect to the external system 22 responsive to a known geographic location of the vehicle 10 being within the threshold range of the external system 22. For example, the communication system 12 may receive a signal from a GPS module of the vehicle 10 indicating that the vehicle is at or near a restaurant that has a drive thru ordering system configured to communicate with the communication system 12. In response to determining that the vehicle is within the threshold range of the compatible geographic location, the communication system 12 transmits a signal to wirelessly connect to the external system 22.

When the vehicle 10 is within the threshold range of the external system 22, the communication system 12 may notify the user that the external system 22 is nearby and prompt the user to accept or decline wireless connection between the communication system 12 and the external system 22. As shown in FIG. 3, the communication system 12 may display a message to the user, such as a connection prompting message 26 at the infotainment display 20, that prompts a response from the user to accept the connection to the external system 22 or to decline connection to the external system 22. That is, once in range, the user receives a notification on the infotainment system that a wireless-enabled external system 22, such as a drive thru speaker, is nearby. The user may also be notified and prompted to accept or decline connection via an audio message or tone, illumination of an icon at the gauge cluster, or other suitable means. Optionally, the user may request the connection between the communication system 12 and the external system 22, such as via input at the infotainment screen 20. Thus, the user has the ability to request, accept, and/or reject connection with the external system 22.

Responsive to the user accepting or confirming or requesting connection between the communication system 12 and the external system 22, communication is enabled between the communication system 12 and the external system 22. The communication system 12 displays messages or images to the user based on communications received from the external system 22, such as by playing audio through the speakers of the vehicle or displaying messages at the infotainment screen 20. The communication system 12 also transmits signals to the external system 22 that are representative of a human-machine interface (HMI), such as user-provided inputs (i.e., user inputs), such as audio signals (based on voice commands by an occupant of the vehicle) captured by microphones inside the vehicle cabin or signals derived from user inputs (e.g., touch-screen inputs, buttons, etc.) at the infotainment screen 20.

In some implementations, the communication system 12 enables two-way audio communication between the user and the external system 22 by capturing audio using the microphones inside the cabin of the vehicle and playing audio at the vehicle speakers. Thus, the driver and occupants are able to speak to someone associated with the external system 22, such as an employee at the restaurant or business, via the vehicle audio system and wireless connection between the communication system 12 and the external system 22. That is, once connection is established, the vehicle audio system will be used so that the users may speak to the ordering system to place orders.

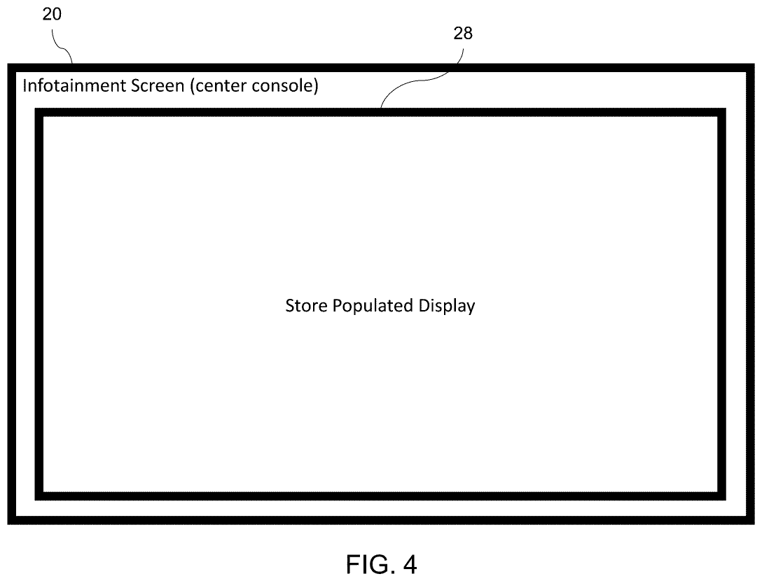

As shown in FIG. 4, the infotainment screen 20 may be used to place orders. When connection between the communication system 12 and the external system 22 is accepted, the infotainment screen 20 displays an interface 28 associated with the external system 22. The interface 28 may be derived from messages or signals received from the external system 22. For example, the interface 28 may include product or menu information related to the business. That is, the infotainment screen 20 may be populated with store information after the connection is accepted. Providing a localized menu display may improve the drive thru ordering process as customers will have more time to review the menu prior to placing an order as compared to traditional drive thru ordering systems where a menu is physically located exterior of the vehicle and at or near an ordering station (e.g., an external microphone and speaker at which the driver may talk to an employee of the business) such that customers may generally only reference the menu when the vehicle is positioned at or near the ordering station. In the illustrated embodiment, the users may reference menu information at the displayed interface 28 while speaking to an employee of the business via the audio systems of the vehicle, or the users may provide inputs at the infotainment screen 20 within the interface 28 to place their order. That is, with the menu displayed at the infotainment screen 20, the displayed interface 28 includes one or more selectable items for the occupant of the vehicle to construct an order via human-machine-interface (HMI), such as by providing user inputs corresponding to the selectable menu items (e.g., via voice commands/selections or via selections at a touch screen of the display device, a cursor, one or more buttons, and the like).

By providing inputs at the infotainment screen 20 (such as by touching a touchscreen or providing inputs associated with the display at the infotainment screen 20), the user may make selections within the interface 28. Based on the selections, one or more signals may be communicated from the communication system 12 to the external system 22 to construct and/or place the order. For example, the signals from the communication system 12 may include order selections and/or payment information for the order. That is, by interacting with the interface 28, the user may construct an order (i.e., choose one or more menu items and/or provide instructions related to chosen menu items) and communicate the order to the external system 22.

Optionally, the communication system 12 may construct the order and generate the signal to transmit to the external system 22 based on audio data captured by the audio systems at the vehicle. That is, the user input may include speech inputs provided to the communication system 12 as audio data captured by microphones within the vehicle. Based on processing of the audio data, the communication system generates the customer order and/or transmits the signal including the customer order to the external system 22. Further, the signal wirelessly transmitted from the communication system 12 to the external system 22 may include the captured audio data, such as to allow the external system 22 to verify the order selected by the communication system 12.

In other words, the user may view the interface 28 at the vehicle display screen and speak to construct the order and/or control the communication system 12 (e.g., to authorize connection to the external system, to transmit the order, and the like). The communication system 12 may perform speech recognition to generate the customer order based on the user's speech inputs and transmit the order to the external system 22. The order may be transmitted to the external system 22 with or without the associated audio. For example, the user may make special requests intended to accompany the order that are transmitted as audio to be played at the external system 22.

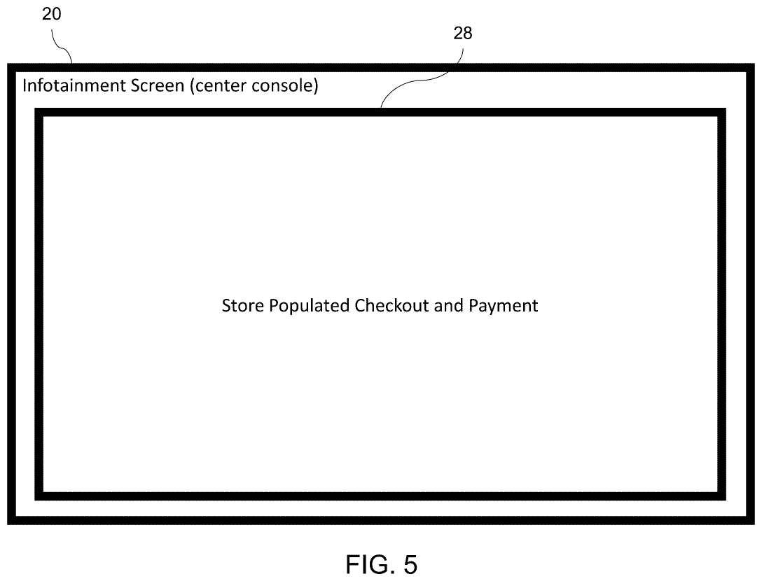

Once the order is received at the external system 22, the user may provide payment in a traditional manner (e.g., provide payment directly to an employee at the business) or the interface 28 at the infotainment screen 20 may provide checkout and payment services (see FIG. 5).

That is, the user may input payment information (e.g., credit card information) at the infotainment screen 20 and the payment information may be communicated to the external system 22 via the communication system 12. Payment information may be communicated in a secure manner, such as via encryption methods and over a secure connection between the communication system 12 and the external system 22. For example, the interface 28 may provide access to a payment portal hosted by the external system 22. Therefore, the user is able to place orders with simple and contactless payment and does not need to physically share a credit card with employees of the business.

Optionally, the communication system 12 may store payment information for the driver or one or more occupants of the vehicle. That is, the user may input or register their payment information, such as through the infotainment screen 20 or a mobile device in communication with the communication system 12, and the communication system 12 may securely store the payment information. Once an order is placed via the communication system 12, the communication system 12 may provide the previously stored credit card information to the external system 22 as payment information for the order. In other words, after menu navigating and cart building, payment is directly made from the vehicle infotainment system using registered information.

Security protocols may be in place to ensure that unauthorized or non-recognized users are prohibited from completing orders using stored payment information. For example, the communication system 12 may require payment to be authorized using a secure code or password input at the infotainment screen 20. Optionally, the vehicle may be equipped with a driver or occupant monitoring system (having a camera viewing interior of the vehicle, such as at a head region of the driver of the vehicle) that is configured to perform facial recognition. Thus, the communication system 12 may register or associate payment information with that of an identity of an authorized user. The driver or occupant monitoring system may perform facial recognition to determine an identity associated with a user of the communication system 12 and determine whether the identity matches an authorized user of the payment information. For example, when payment information is selected from payment information stored in memory of the communication system 12 (e.g., in memory at the ECU), the communication system 12 may determine whether the driver or any occupant in the vehicle is an authorized user for the payment information. Payment information may be associated with the identity of more than one authorized user. Failure to match the identity of a user of the communication system 12 with the identify of an authorized user may be treated as an unauthorized use of the payment information, in which case the communication system will not place the order or communicate the payment information to the external system 22.

Responsive to determining that the user is an authorized user, the communication system 12 may complete the order and communicate the payment information to the external system 22. Therefore, all payments attempted using the communication system 12 using a stored credit card may be authenticated with driver or occupant facial detection. The communication system 12 ensures that payment information is processed only when the facial recognition identifies the driver as an authorized user of the registered credit card and the communication system 12 does not allow unauthorized usage of payment stored by the communication system 12.

Thus, the communication system 12 enables wireless one-way or two-way communication between a user of the communication system 12 within the vehicle 10 and the external system 22 having the antenna 24 at a location or business or at least within a threshold distance range of the vehicle 10. Communications from the user to the external system 22 may include sounds or audio data captured by microphones within the vehicle, signals or messages derived from inputs at the display screen 20 of the vehicle, or automatically transmitted communications (such as a signal requesting connection to the external system 22, a signal to the external system 22 including identification information of the driver or vehicle, and the like). Communications from the external system 22 to the communication system 12 may include sounds or audio to be played at speakers within the vehicle, and signals or messages to be displayed at the display screen 20 of the vehicle (such as displaying a menu or point-of-sale (POS) interface (including cart building and checkout services), messages related to an order placed (such as an estimated time to completion or position of the order within a queue), or other messages or images (such as promotional messages)). The communication system 12 provides a secure and efficient way for users to communicate with external systems 22 when in proximity of the establishment hosting the external system 22.

Optionally, the communication system 12 may automatically transmit information (such as a customer order or identity information related to an occupant of the vehicle) in response to wirelessly connecting to the external system 22. For example, when the vehicle travels within range of the external system 22 (e.g., enters the parking lot of a business), the communication system 12 may connect with the external system 22 and transmit a customer order stored in memory and related to the venue associated with the external system. By way of example, if the business is a coffee shop, the occupant or user may have a favorite coffee order stored in memory of the vehicle so that, when the vehicle is within range of the external system 22 associated with the coffee shop, the communication system 12 may transmit the favorite order to the external system 22. The communication system 12 may request authorization from the occupant before transmitting the customer order. Similarly, the communication system 12 may automatically transmit identification information to the external system 22 upon connecting to the external system 22 to alert the business associated with the external system 22 that the occupant has arrived to pick up a previously placed order.

Optionally, the communication system 12 may be operable to provide different levels or stages of communicability between the external system 22 and the communication system 12 based on, for example, proximity of the vehicle to the geographical location associated with the communication system 12, inputs provided by the user of the communication system 12 and/or signals received by the communication system 12 from the external system 22. For example, when the vehicle first comes within range of the external system 22 (e.g., enters the parking lot at the restaurant), the communication system 12 may display a welcome message from the external system 22 and the communication system 12 may prompt the user to accept or decline connection with the external system 22. Upon accepting connection to the external system 22, the communication system 12 may request and/or receive menu information to provide the interface 28 at the vehicle display screen 20. Via inputs at the display screen 20, the user may construct and submit an order to the external system 22. Optionally, the user may request a more direct level of communication with the external system 22 (e.g., audio communication with an employee of the associated business), such as to place the order or ask questions about information provided at the interface 28.

Optionally, the more direct level of communication may be provided when the vehicle is in closer proximity to the geographical location. For example, the communication system 12 may display menu information when the vehicle enters the parking lot at the restaurant and then enable audio communication with the external system 22 when the vehicle is positioned in a drive thru line or at a designated ordering and/or pickup location (e.g., a parking spot associated with curbside ordering). Thus, when the vehicle is within a first threshold distance of the geographical location associated with the external system, a first level or communication type between the communication system 12 and the external system 22 is enabled and, when the vehicle is within a second threshold distance (that is less than the first threshold distance), a second level or communication type is enabled.

Although described herein as connecting the vehicle to the drive thru ordering system, it should be understood that the communication system may wirelessly communicate with a variety of different external systems at geographic locations or businesses or other venues proximal to the vehicle. For example, the communication system may wirelessly communicate with an audio system at a drive-in movie theater so that audio from the movie theater may be played through the speakers of the vehicle. The user may further communicate with the external system associated with the drive-in movie theater, such as to order from a concession stand or change audio to another language.

When the vehicle approaches an external system associated with a restaurant, the communication system may wirelessly communicate with the restaurant to learn a wait time for a table at the restaurant and prompt the driver to place their name in a queue for the restaurant via messages at the infotainment screen. Similarly, when the vehicle approaches a reservation or appointment-based location or business, such as a doctor's office or dentist's office or veterinary office or mechanic's shop or governmental services location, such as the Department of Motor Vehicles office or Secretary of State office, the communication system may wirelessly communicate with an external system associated with the business or service location to notify the business of the driver's arrival and to subsequently notify the driver that the business is ready for the driver to enter for their appointment. Thus, the driver and occupants may wait for their reservation or appointment in the comfort of their vehicle and only need enter the business or restaurant when they have reached the front of the queue. Moreover, the communication system 12 may connect to an external system 22 at a nature site (such as a state park) so that the users may exchange communications with the external system 22, such as to participate in a guided tour of the nature site.

Optionally, the communication system 12 may connect to an external system 22 associated with other businesses or pickup locations, such as banks, pharmacies, schools, retail stores with online ordering with curbside or in-store pickup, and the like. The communication system 12 provides secure connection and secure communication with the external system, such as via encrypted communication protocols and facial recognition using the driver monitoring system of the vehicle, to protect sensitive information shared between the communication system 12 and external system 22, such as payment information, banking information, prescription and medical information and the like.

Optionally, the communication system 12 may utilize the driver monitoring camera of the vehicle to enable video communications between the user and the external system 22. For example, the external system 22 may be associated with a bank or pharmacy (or other location that might require or request confirmation of the user's identity to provide service) and the communication system 12 may transmit video images derived from image data captured by the driver monitoring camera to the external system 22.

Furthermore, the communication system 12 may wirelessly connect to any suitable external system 22 having the antenna 24 within the threshold range of the communication module of the communication system 12. For example, the antenna 24 may be disposed at a police vehicle so that a police officer within the police vehicle may wirelessly communicate with the driver of the vehicle 10 during a traffic stop (e.g., via audio and/or video communications). In a further example, the external system 22 may be hosted at a toll booth or by a parking lot attendant so that the user may communicate with and provide payment information to the toll booth or parking lot attendant without lowering a window or exiting the vehicle.

The system may utilize one or more cameras or sensors (such as for facial recognition or for external sensing), which may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The system may also communicate with other systems, such as via a vehicle-to-vehicle communication system or a vehicle-to-infrastructure communication system or the like. Such car2car or vehicle to vehicle (V2V) and vehicle-to-infrastructure (car2X or V2X or V2I or a 4G or 5G broadband cellular network) technology provides for communication between vehicles and/or infrastructure based on information provided by one or more vehicles and/or information provided by a remote server or the like. Such vehicle communication systems may utilize aspects of the systems described in U.S. Pat. Nos. 10,819,943; 9,555,736; 6,690,268; 6,693,517 and/or 7,580,795, and/or U.S. Publication Nos. US-2014-0375476; US-2014-0218529; US-2013-0222592; US-2012-0218412; US-2012-0062743; US-2015-0251599; US-2015-0158499; US-2015-0124096; US-2015-0352953; US-2016-0036917 and/or US-2016-0210853, which are hereby incorporated herein by reference in their entireties.

The system may utilize aspects of driver monitoring systems and/or head and face direction and position tracking systems and/or eye tracking systems and/or gesture recognition systems. Such head and face direction and/or position tracking systems and/or eye tracking systems and/or gesture recognition systems may utilize aspects of the systems described in U.S. Pat. Nos. 11,518,401; 10,958,830; 10,065,574; 10,017,114; 9,405,120 and/or 7,914,187, and/or U.S. Publication Nos. US-2022-0377219; US-2022-0254132; US-2022-0242438; US-2021-0323473; US-2021-0291739; US-2020-0320320; US-2020-0202151; US-2020-0143560; US-2019-0210615; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or International Publication Nos. WO 2023/034956; WO 2022/241423 and/or WO 2022/187805, and/or PCT Application No. PCT/US2023/021799, filed May 11, 2023 (Attorney Docket DON01 FP4810WO), which are all hereby incorporated herein by reference in their entireties.

Optionally, the vision system may include a display for displaying images captured by one or more of the imaging sensors for viewing by the driver of the vehicle while the driver is normally operating the vehicle. Optionally, for example, the vision system may include a video display device, such as by utilizing aspects of the video display systems described in U.S. Pat. Nos. 5,530,240; 6,329,925; 7,855,755; 7,626,749; 7,581,859; 7,446,650; 7,338,177; 7,274,501; 7,255,451; 7,195,381; 7,184,190; 5,668,663; 5,724,187; 6,690,268; 7,370,983; 7,329,013; 7,308,341; 7,289,037; 7,249,860; 7,004,593; 4,546,551; 5,699,044; 4,953,305; 5,576,687; 5,632,092; 5,708,410; 5,737,226; 5,802,727; 5,878,370; 6,087,953; 6,173,501; 6,222,460; 6,513,252 and/or 6,642,851, and/or U.S. Publication Nos. US-2014-0022390; US-2012-0162427; US-2006-0050018 and/or US-2006-0061008, which are all hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular communication system, the vehicular communication system comprising:
an electronic control unit (ECU) disposed at a vehicle equipped with the vehicular communication system, wherein the ECU comprises electronic circuitry and associated software;
wherein, when the vehicle is within a threshold distance of a venue, the vehicular communication system is in wireless communication with a communication device at the venue;
wherein the threshold distance is less than or equal to 1,000 meters;
wherein the communication device at the venue wirelessly communicates information to the vehicle, and wherein the communicated information comprises information related to at least one selected from the group consisting of (i) a product provided at the venue and (ii) a service provided at the venue; and
wherein, based at least in part on processing at the ECU of the communicated information, a customer order from an occupant of the vehicle is wirelessly transmitted from the vehicle to the communication device at the venue.

2. The vehicular communication system of claim 1, wherein the communicated information comprises a menu of selectable items, and wherein the customer order is created by the occupant selecting at least one item from the menu of selectable items.

3. The vehicular communication system of claim 2, wherein the menu of selectable items is displayed at a display device disposed at an interior portion of the vehicle.

4. The vehicular communication system of claim 3, wherein the menu of selectable items is disposed at a touch screen of the display device, and wherein the customer order is created by the occupant touch-selecting at least one item from the menu of selectable items.

5. The vehicular communication system of claim 2, wherein the customer order is created via an audio input provided by the occupant, and wherein the audio input is captured by a microphone disposed at an interior portion of the vehicle.

6. The vehicular communication system of claim 5, wherein the customer order wirelessly transmitted from the vehicle to the communication device at the venue comprises audio data related to the audio input.

7. The vehicular communication system of claim 1, wherein the information wirelessly communicated from the communication device at the venue to the vehicle comprises audio data that is played at a speaker disposed at an interior portion of the vehicle to enable audio communication between the occupant of the vehicle and a person at the venue.

8. The vehicular communication system of claim 7, wherein the customer order wirelessly transmitted from the vehicle to the communication device at the venue comprises audio data captured by a microphone disposed at the interior portion of the vehicle.

9. The vehicular communication system of claim 1, wherein the customer order wirelessly transmitted from the vehicle to the communication device at the venue comprises payment information.

10. The vehicular communication system of claim 9, wherein the vehicular communication system wirelessly transmits the payment information to the communication device responsive to determination that the occupant is authorized to utilize the payment information.

11. The vehicular communication system of claim 10, wherein the vehicular communication system determines that the occupant is authorized to utilize the payment information based on an authorization code.

12. The vehicular communication system of claim 10, wherein the vehicular communication system determines that the occupant is authorized to utilize the payment information when, based on processing of image data captured by a camera of a driver monitoring system of the vehicle, a determined identity of the occupant corresponds to an authorized identity associated with the payment information.

13. The vehicular communication system of claim 1, wherein the venue comprises a restaurant, and wherein the communication device comprises part of a drive-thru ordering system at the restaurant.

14. The vehicular communication system of claim 1, wherein the threshold distance is less than or equal to 100 meters.

15. The vehicular communication system of claim 1, wherein the threshold distance is less than or equal to 10 meters.

16. The vehicular communication system of claim 15, wherein the vehicular communication system wirelessly communicates with the communication device via BLUETOOTH® technology.

17. The vehicular communication system of claim 1, wherein the threshold distance is based on a geographic region associated with the venue.

18. The vehicular communication system of claim 1, wherein the vehicular communication system enables wireless communication with the communication device at the venue responsive to receiving authorization from the occupant.

19. A vehicular communication system, the vehicular communication system comprising:
an electronic control unit (ECU) disposed at a vehicle equipped with the vehicular communication system, wherein the ECU comprises electronic circuitry and associated software;
wherein, when the vehicle is within a threshold distance of a venue, the vehicular communication system is in wireless communication with a communication device at the venue;
wherein the threshold distance is less than or equal to 1,000 meters;
wherein the communication device at the venue wirelessly communicates information to the vehicle, and wherein the communicated information comprises information related to at least one selected from the group consisting of (i) a product provided at the venue and (ii) a service provided at the venue;
wherein, based at least in part on processing at the ECU of the communicated information, a customer order from an occupant of the vehicle is wirelessly transmitted from the vehicle to the communication device at the venue;
wherein the communicated information comprises a menu of selectable items, and wherein the customer order comprises a selection made by the occupant of at least one item from the menu of selectable items; and
wherein the customer order wirelessly transmitted from the vehicle to the communication device at the venue comprises payment information.

20. The vehicular communication system of claim 19, wherein the customer order wirelessly transmitted from the vehicle to the communication device at the venue comprises audio data captured by a microphone disposed at an interior portion of the vehicle.

21. The vehicular communication system of claim 19, wherein the menu of selectable items is displayed at a display device disposed at an interior portion of the vehicle.

22. The vehicular communication system of claim 21, wherein the menu of selectable items is displayed at a touch screen of the display device, and wherein the customer order is created by the occupant touch-selecting at least one item from the menu of selectable items.

23. The vehicular communication system of claim 19, wherein the vehicular communication system wirelessly transmits the payment information to the communication device responsive to determination that the occupant is authorized to utilize the payment information.

24. The vehicular communication system of claim 23, wherein the vehicular communication system determines that the occupant is authorized to utilize the payment information based on an authorization code.

25. The vehicular communication system of claim 23, wherein the vehicular communication system determines that the occupant is authorized to utilize the payment information when, based on processing of image data captured by a camera of a driver monitoring system of the vehicle, a determined identity of the occupant corresponds to an authorized identity associated with the payment information.

26. The vehicular communication system of claim 19, wherein the venue comprises a restaurant, and wherein the communication device comprises part of a drive-thru ordering system at the restaurant.

27. The vehicular communication system of claim 19, wherein the threshold distance is less than or equal to 100 meters.

28. The vehicular communication system of claim 19, wherein the threshold distance is less than or equal to 10 meters.

29. The vehicular communication system of claim 28, wherein the vehicular communication system wirelessly communicates with the communication device via BLUETOOTH® technology.

30. The vehicular communication system of claim 19, wherein the threshold distance is based on a geographic region associated with the venue.

31. A vehicular communication system, the vehicular communication system comprising:
an electronic control unit (ECU) disposed at a vehicle equipped with the vehicular communication system, wherein the ECU comprises electronic circuitry and associated software;
wherein, when the vehicle is within a threshold distance of a venue, the vehicular communication system is in wireless communication with a communication device at the venue;
wherein the threshold distance is less than or equal to 1,000 meters;
wherein the communication device at the venue wirelessly communicates information to the vehicle, and wherein the communicated information comprises information related to at least one selected from the group consisting of (i) a product provided at the venue and (ii) a service provided at the venue;
wherein the communication device comprises part of a drive-thru ordering system at the venue;
wherein, based at least in part on processing at the ECU of the communicated information, a customer order from an occupant of the vehicle is wirelessly transmitted from the vehicle to the communication device at the venue;
wherein the communicated information comprises a menu of selectable items;
wherein the menu of selectable items is displayed at a display device disposed at an interior portion of the vehicle;
wherein the customer order comprises a selection made by the occupant of at least one item from the menu of selectable items that is displayed at the display device disposed at the interior portion of the vehicle; and
wherein the customer order wirelessly transmitted from the vehicle to the communication device at the venue comprises payment information.

32. The vehicular communication system of claim 31, wherein the customer order wirelessly transmitted from the vehicle to the communication device at the venue comprises audio data captured by a microphone disposed at an interior portion of the vehicle.

33. The vehicular communication system of claim 31, wherein the vehicular communication system wirelessly transmits the payment information to the communication device responsive to determination that the occupant is authorized to utilize the payment information.

34. The vehicular communication system of claim 33, wherein the vehicular communication system determines that the occupant is authorized to utilize the payment information based on an authorization code.

35. The vehicular communication system of claim 33, wherein the vehicular communication system determines that the occupant is authorized to utilize the payment information when, based on processing of image data captured by a camera of a driver monitoring system of the vehicle, a determined identity of the occupant corresponds to an authorized identity associated with the payment information.

36. The vehicular communication system of claim 31, wherein the venue comprises a restaurant.

37. The vehicular communication system of claim 31, wherein the menu of selectable items is displayed at a touch screen of the display device, and wherein the customer order is created by the occupant touch-selecting at least one item from the menu of selectable items.

38. The vehicular communication system of claim 31, wherein the threshold distance is less than or equal to 100 meters.

39. The vehicular communication system of claim 31, wherein the threshold distance is less than or equal to 10 meters.

40. The vehicular communication system of claim 39, wherein the vehicular communication system wirelessly communicates with the communication device via BLUETOOTH® technology.

41. The vehicular communication system of claim 31, wherein the threshold distance is based on a geographic region associated with the venue.
